(19) United States
(12) Patent Application Publication
(10) Pub. No.: US 2023/0050462 A1
(43) Pub. Date: Feb. 16, 2023

(54) SUSCEPTOR FOR A CONSUMABLE USED WITH A NON-COMBUSTIBLE AEROSOL PROVISION DEVICE

(71) Applicant: Nicoventures Trading Limited, London (GB)

(72) Inventors: Patrick MOLONEY, London (GB); Anton KORUS, London (GB)

(21) Appl. No.: 17/792,728

(22) PCT Filed: Oct. 30, 2020
(86) PCT No.: PCT/GB2020/052759

§ 371 Date: Jul. 14, 2022

(30) Foreign Application Priority Data
Jan. 16, 2020 (GB) 2000684.7

(51) Int. Cl. A24F 40/465; A24D 1/20; A24F 40/20; A24C 5/01; H05B 6/10; H05B 6/44

(52) U.S. Cl. CPC A24F 40/465; A24D 1/20; A24F 40/20; A24C 5/01; H05B 6/105; H05B 6/44

(57) ABSTRACT

According to the present disclosure, there is provided a susceptor (1) for at least partially embedding within an object (2) during manufacture of a consumable for use with a non-combustible aerosol provision device. The object comprises aerosol-generating material (3). At least a portion of the susceptor has a non-linear cross-sectional shape (4) perpendicular to a length of the susceptor. here is also provided a method of manufacturing a susceptor, a consumable for use with a non-combustible aerosol provision device, a method of manufacturing a consumable, and a non-combustible aerosol provision system.

### TECHNICAL FIELD

The present invention relates to a susceptor for at least partially embedding within an object during manufacture of a consumable for use with a non-combustible aerosol provision device, to a method of manufacturing a susceptor for at least partially embedding within an object during manufacture of a consumable, to a method of manufacturing a consumable for use with a non-combustible aerosol provision device, and to a non-combustible aerosol provision system.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

According to a first aspect of the present invention, there is provided a susceptor for at least partially embedding within an object during manufacture of a consumable for use with a non-combustible aerosol provision device, the object comprising aerosol-generating material, wherein the susceptor is heatable by penetration with a varying magnetic field, and wherein at least a portion of the susceptor has a non-linear cross-sectional shape perpendicular to a length of the susceptor.

Optionally, the susceptor comprises a surface with at least one indentation therein, wherein the surface and the at least one indentation forms the non-linear cross-sectional shape.

Optionally, the susceptor comprises at least one corrugation therein running parallel to the length of the susceptor, wherein the at least one corrugation forms the non-linear cross-sectional shape.

Optionally, the non-linear cross-sectional shape is or comprises a crescent.

Optionally, at least one longitudinal end of the susceptor is tapered to aid insertion of the susceptor into the object.

According to a second aspect of the present invention, there is provided a method of manufacturing a susceptor for at least partially embedding within an object during manufacture of a consumable for use in a non-combustible aerosol provision device, the object comprising aerosol-generating material, the method comprising: providing at least a portion of a strip with a non-linear cross-sectional shape perpendicular to a length of the strip, the strip comprising susceptor material that is heatable by penetration with a varying magnetic field.

Optionally, the method comprises dividing the strip from a supply.

Optionally, the dividing comprises using a cutter to cut the strip from the supply.

Optionally, the providing occurs after the dividing.

Optionally, the dividing occurs after the providing.

According to a third aspect of the present invention, there is provided a consumable for use with a non-combustible aerosol provision device, the consumable comprising an object comprising aerosol-generating material and the susceptor according to the first aspect of the present invention at least partially embedded in the object.

Optionally, the susceptor is substantially coaxial with a central axis of the consumable.

According to a fourth aspect of the present invention, there is provided a method of manufacturing a consumable for use with a non-combustible aerosol provision device, the method comprising: providing an object and the susceptor according to the first aspect of the present invention, wherein the object comprises aerosol-generating material; and moving the susceptor and the object relative to each other so that the susceptor becomes at least partially embedded within the object.

According to a fifth aspect of the present invention, there is provided a method of manufacturing a consumable for use with a non-combustible aerosol provision device, the method comprising: providing an object, the object comprising aerosol-generating material; providing a susceptor; and pulling the susceptor to at least partially embed the susceptor in the object.

Optionally, the pulling comprises: engaging a tool with the susceptor; and then using the tool to pull the susceptor at least partially into the object.

Optionally, the engaging comprises gripping the susceptor with the tool.

Optionally, the method comprises disengaging the tool from the susceptor when the susceptor is at least partially embedded in the object.

Optionally, the susceptor comprises one or more materials selected from the group consisting of: aluminium, gold, iron, nickel, cobalt, conductive carbon, graphite, steel, plain-carbon steel, mild steel, stainless steel, ferritic stainless steel, molybdenum, silicon carbide, copper, and bronze.

Optionally, the susceptor comprises nickel.

Optionally, the susceptor comprises steel with a nickel coating.

Optionally, the susceptor is hollow or perforated, or comprises indentations, a mesh or an expanded metal.

Optionally, the susceptor comprises a, pin, mesh or blade.

Optionally, the susceptor comprises a plurality of pins, meshes or blades.

Optionally, the susceptor comprising a plurality of apertures or recesses, wherein the apertures and/or recesses are filled with the aerosol-generating material when the susceptor is at least partially embedded in the object.

Optionally, at least part of the susceptor is annular.

Optionally, the susceptor comprises a plurality of annular portions and, preferably, wherein the annular portions are arranged generally concentrically.

Optionally, the aerosol-generating material is non-liquid.

Optionally, the aerosol-generating material comprises tobacco.

Optionally, the susceptor extends the majority of the length of the object after the susceptor has been at least partially embedded in the object and, preferably, the susceptor extends substantially the entire length of the object after the susceptor has been at least partially embedded in the object.

Optionally, the susceptor comprises a first region of a first material and a second region of a second material, wherein the first and second materials are different.

Optionally, the first and second materials have a different electrical conductivity and/or magnetic electrical conductivity.

Optionally, one of the first material comprises a material that is heatable by penetration with a varying magnetic field and the second material comprises a material that is not, or substantially is not, heatable by penetration with a varying magnetic field.

Optionally, one of first and second materials is coated with the other one of the first and second materials.

Optionally, the first material is coated with the second material.

Optionally, the first and second materials are configured such that, in use, when the first and second materials are penetrated by a varying magnetic field, the penetration of the first and second materials by the varying magnetic field causes a temperature difference between the first and second materials.

Optionally, the first and second materials have different thermal masses.

Optionally, the susceptor comprises a base portion and an embeddable portion, wherein the embeddable portion is configured to be at least partially embedded in the object.

Optionally, the base portion is generally flat.

Optionally, the base portion is generally circular.

Optionally, the base portion is comprises a material that is heatable by penetration with a varying magnetic field.

Optionally, the embeddable portion comprises a thermally conductive material.

Optionally, the embeddable portion comprises a material that is heatable by penetration with a varying magnetic field.

Optionally, the embeddable portion comprises a material that is not, or substantially is not, heatable by penetration with a varying magnetic field.

Optionally, the embeddable portion comprises the first and second materials.

Optionally, the embeddable portion comprises one of the first and second materials and the base portion comprises the other one of the first and second materials.

The features described hereinbefore, including the features of the susceptor and/or aerosol-generating material, are applicable to any of the aspects of the invention described herein.

According to a sixth aspect of the present invention, there is provided a consumable for use with a non-combustible aerosol provision device, the consumable being manufactured according to a method comprising the method according to the fourth aspect of the present invention.

Optionally, the susceptor is substantially coaxial with a central axis of the consumable.

According to a seventh aspect of the present invention, there is provided a non-combustible aerosol provision system, comprising: the consumable according to the third or sixth aspect of the present invention; and a non-combustible aerosol provision device for causing heating of the aerosol-generating material of the consumable to volatilise at least one component of the aerosol-generating material; wherein the device comprises a heating zone for receiving the consumable, and a magnetic field generator for generating a varying magnetic field for penetrating the susceptor when the consumable is at least partially in the heating zone, thereby to cause heating of the aerosol-generating material.

Optionally, the apparatus is for causing heating of the aerosol-generating material of the consumable to volatilise at least one component of the aerosol-generating material without burning the aerosol-generating material.

Optionally, the magnetic field generator comprises at least one coil.

Optionally, the coil is helical.

Optionally, the coil is a flat coil and may be a two-dimensional spiral.

Optionally, the system comprises a second coil and, preferably, the second coil is helical.

Optionally, the magnetic field generator is configured to generate a varying magnetic field for penetrating the base portion of the susceptor when the consumable is at least partially in the heating zone.

Optionally, the coil is configured to generate a varying magnetic field for penetrating the base portion of the susceptor when the consumable is at least partially in the heating zone and wherein the second coil is configured to generate a varying magnetic field for penetrating the embeddable portion of the susceptor when the consumable is at least partially in the heating zone.

Optionally, the second coil extends about the circumference of at least a portion of the embeddable portion of the susceptor.

Optionally, the susceptor comprises one or more materials selected from the group consisting of: an electrically-conductive material, a magnetic material, and a magnetic electrically-conductive material.

Optionally, the susceptor comprises a metal or a metal alloy.

Optionally, the susceptor comprises one or more materials selected from the group consisting of: aluminium, gold, iron, nickel, cobalt, conductive carbon, graphite, steel, plain-carbon steel, mild steel, stainless steel, ferritic stainless steel, molybdenum, silicon carbide, copper, and bronze.

Optionally, the aerosol-generating material is a non-liquid material.

Optionally, the aerosol-generating material comprises tobacco.

Optionally, the aerosol-generating material is reconstituted aerosol-generating material, such as reconstituted tobacco.

Further features and advantages of the invention will become apparent from the following description of preferred embodiments of the invention, given by way of example only, which is made with reference to the accompanying drawings.

### BRIEF DESCRIPTION OF THE DRAWINGS

Embodiments of the invention will now be described, by way of example only, with reference to accompanying drawings, in which:

FIG. 1 shows a schematic cross-sectional view of a susceptor according to an embodiment of the present invention.

FIG. 2 shows a schematic cross-sectional view of a susceptor according to an embodiment of the present invention.

FIG. 3 shows a schematic view of a susceptor according to an embodiment of the present invention.

FIG. 4 shows a flow chart of a method according to an embodiment of the present invention.

FIG. 5 shows a flow chart of a method according to an embodiment of the present invention.

FIG. 6 shows a flow chart of a method according to an embodiment of the present invention.

FIG. 7 shows a schematic cross-sectional view of a consumable according to an embodiment of the present invention.

FIG. 8 shows a schematic view of a non-combustible aerosol provision system according to an embodiment of the present invention.

### DETAILED DESCRIPTION

As used herein, “aerosol-generating material” is material that is capable of generating aerosol, for example when heated, irradiated or energized in any other way. Aerosol-generating material may, for example, be in the form of a solid, liquid or gel which may or may not contain an active substance and/or flavourants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavours, one or more aerosol-former materials, and optionally one or more other functional materials.

In some embodiments, the aerosol-generating material may comprise tobacco material, wherein tobacco material is any material comprising tobacco or derivatives thereof. The tobacco material may comprise one or more of ground tobacco, tobacco fibre, cut tobacco, extruded tobacco, tobacco stem, reconstituted tobacco and/or tobacco extract. In some embodiments, the aerosol-generating material may comprise a tobacco substitute.

As used herein, a “consumable” is an item comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use.

As used herein, a “susceptor” is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms.

When a susceptor is incorporated into a consumable, as heat is generated inside the consumable itself, rather than by an external heat source by heat conductions, a rapid temperature rise in the consumable and more uniform heat distribution can be achieved, particularly through the selection of suitable materials and geometry, and suitable varying magnetic field magnitude and orientation relative to the susceptor.

Moreover, as induction heating and magnetic hysteresis heating do not require physical connection to be provided between the source of the varying magnetic field and the susceptor, material deposits on the susceptor, such as residue or condensate, may be less of an issue, design freedom and control over the heating profile may be greater, and cost may be lower.

During manufacture of a consumable, for example a consumable for use with a non-combustible aerosol provision device, aerosol-generating material such as tobacco is placed on a paper. The paper is then wrapped around the aerosol-generating material to encase the aerosol-generating material and create a rod. The rod is cut to a desired length, and a filter may subsequently be attached, to form the consumable.

A susceptor may be provided within such a consumable in order to enable heating of the consumable in any of the ways discussed above. However, if the susceptor is provided as a continuous item through the rod before the rod is cut to length, damage may be caused to the cutting instrument when the rod is cut to the desired length online.

FIG. 1 shows a schematic view of an object 2 in which a susceptor 1 according to one embodiment is at least partially embedded. FIG. 1 shows a cross-sectional view perpendicular to a length of the susceptor 1 (that is, FIG. 1 shows a width and a height of the susceptor 1, with the susceptor 1 extending into the page). The susceptor 1 is for at least partially embedding within an object 2 during manufacture of a consumable for use with a non-combustible aerosol provision device. In some embodiments the susceptor 1 is completely embedded within the object 2 such that no part of the susceptor 1 extends beyond the outer surface of the object 2. The object 2 comprises aerosol-generating material 3. At least a portion of the susceptor 1 has a non-linear cross-sectional shape 4 perpendicular to the length of the susceptor. As shown in FIG. 1, in one embodiment the non-linear cross-sectional shape is or comprises a crescent. In some embodiments, the non-linear cross-sectional shape is polygonal, curved and/or curvilinear, or comprises polygonal, curved and/or curvilinear portions.

As used herein, the term “linear cross-sectional shape” should be understood to mean a cross-sectional shape perpendicular to the length of the susceptor 1 which is or approximates a single straight line. For example, if a susceptor 1 has a rectangular cross-sectional shape perpendicular to the length of the susceptor 1, then such a susceptor can be considered to approximate a single straight line (having a thickness of the height of the susceptor 1). Another way to view this is that the primary surfaces of the susceptor 1 (i.e., the top and bottom surfaces of the rectangular cross-sectional shape) each lie entirely in a single flat plane, where each plane is parallel with respect to one another.

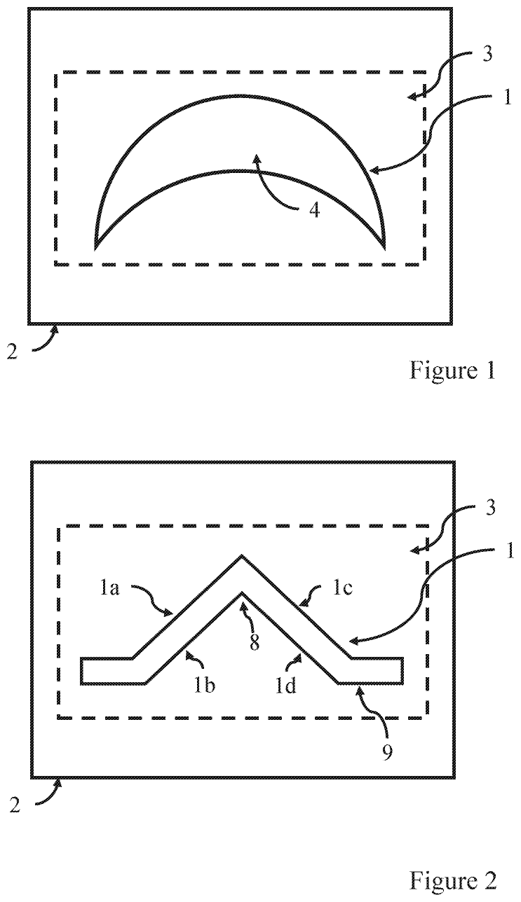

As used herein, the term “non-linear cross-sectional shape” should be understood to include any cross-sectional shape which is not, or does not approximate, a single straight line. It should be appreciated that a “non-linear cross-sectional shape” may include cross-sectional shapes which are or approximate a plurality of straight, non-parallel lines. For example, as shown in FIG. 2, two non-parallel straight lines may be arranged to form a pointed structure whereby the two straight lines abut to form the point. As shown in FIG. 2, the surfaces 1a and 1b are parallel and lie along a first direction, while surfaces 1c and 1d are parallel and lie along a second direction (which is non-parallel to the first direction).

FIG. 2 shows a schematic view of an object 2 in which a susceptor 1 according to one embodiment is at least partially embedded. The object 2 comprises aerosol-generating material 3. In the embodiment shown in FIG. 2, at least one surface 9 of the susceptor 1 comprises an indentation 8 therein. In the embodiment of FIG. 2, the indentation 8 is elongated and extends parallel to a length of the susceptor 1 along the length of the susceptor. In some embodiments, the indentation 8 is provided at a single point on the susceptor 1. In some embodiments, as shown in FIG. 2, the non-linear cross-sectional shape may form, or be formed by, a ridge or indentation 8 provided along at least a portion of the length of the susceptor 1. In some embodiments, the indentation(s) 8 form(s) the corrugation(s) 5. In some embodiments, the surface 9 is omitted and the susceptor 1 comprises one or more corrugations 5. In some embodiments, the indentation(s) 8 do/does not form corrugation(s) 5; for example, the indentation(s) 8 may form one or more islands, such as circular islands, that are indented in the surface 9.

In the embodiments shown in FIGS. 1 and 2, the susceptor 1 is disposed at least partially within the aerosol-generating material 3. Alternatively, the susceptor 1 may be disposed in the object 2 either adjacent one edge of the aerosol-generating material 3 or remote from the aerosol-generating material 3.

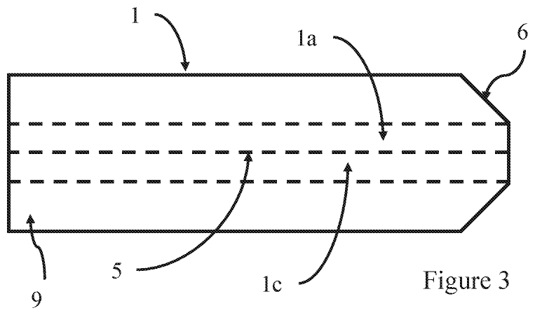

FIG. 3 shows a schematic view of the susceptor 1 of FIG. 2 from above. The susceptor 1 comprises at least one corrugation 5 parallel to a length of the susceptor 1. The corrugation 5 is formed by an elongate indentation 8 in surface 9 (shown in FIG. 2). In some embodiments, the at least one corrugation 5 forms the non-linear cross-sectional shape of the susceptor 1. For example, in the embodiment shown in FIG. 3, the corrugation 5 forms the non-linear cross-sectional shape shown in FIG. 2. In some embodiments, the non-linear cross-sectional shape formed by the corrugation 5 may have a different shape or profile to that shown in FIG. 2

Advantageously, the non-linear cross-sectional shape of the susceptor 1 may help to increase the strength and/or rigidity of the susceptor 1 along its length, allowing it to substantially resist buckling when a force is applied in a direction along its length to a greater extent compared to a comparable susceptor having a linear cross-sectional shape. For example, the susceptor 1 may be pushed into the object 2 (in some embodiments, specifically the aerosol-generating material 3 of the object 2) from a longitudinal end of the object 2. The non-linear cross-sectional shape of the susceptor 1 may make the pushing easier, as the susceptor 1 is less likely to bend or deform.

As shown in FIG. 3, in some embodiments at least one longitudinal end of the susceptor 1 is tapered 6. The taper 6 further aids insertion of the susceptor 1 into the object 2. In some embodiments, the susceptor 1 may taper to a point at the at least one longitudinal end of the susceptor 1. In some embodiments, both longitudinal ends of the susceptor 1 are tapered such that the susceptor 1 can be more easily inserted into the object 2 either way around. In other embodiments, only one longitudinal end is tapered. It should be appreciated that the taper 6 may be present for any non-linear cross-sectional shape of the susceptor 1.

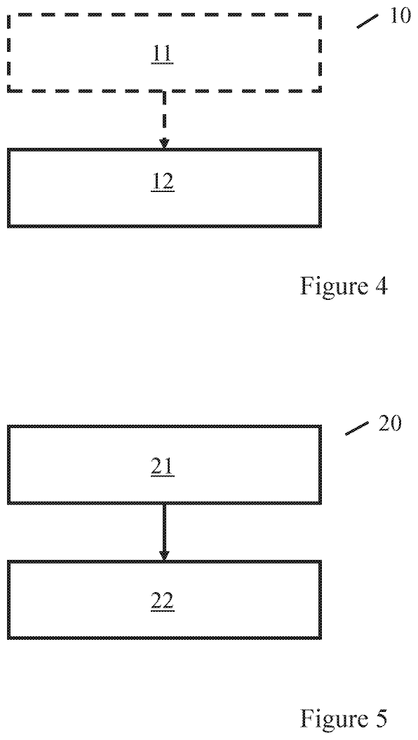

FIG. 4 shows a flow diagram of a method 10 of manufacturing a susceptor 1 for at least partially embedding within an object 2 during manufacture of a consumable for use in a non-combustible aerosol provision device, the object 2 comprising aerosol-generating material 3, according to one embodiment. The method 10 comprises providing 12 at least a portion of a strip with a non-linear cross-sectional shape perpendicular to a length of the strip, the strip comprising susceptor material that is heatable by penetration with a varying magnetic field. As shown in FIG. 4, in some embodiments, the method comprises dividing 11 a strip from a supply. In some embodiments, the dividing 11 may comprise using a cutter to cut the strip from the supply.

In some embodiments, the providing 12 occurs after the dividing 11. Alternatively, the dividing 11 occurs after the providing 12.

FIG. 5 shows a flow diagram of a method 20 of manufacturing a consumable for use with a non-combustible aerosol provision device, according to one embodiment. The method 20 comprises providing 21 an object 2 and a susceptor 1, wherein the object 2 comprises aerosol-generating material 3. The susceptor 1 may be any susceptor 1 illustrated and described herein, or any variant thereof described herein, for example. For example, it may be a susceptor 1 made according to the method illustrated in FIG. 4. The method 20 further comprises moving 22 the susceptor 1 and the object 2 relative to each other so that the susceptor 1 becomes at least partially embedded within the object 2. The susceptor 1 may become fully embedded within the object 2.

In some embodiments, the susceptor 1 is moved towards the object 2 while the object 2 is held in position. Alternatively, the object 2 is moved towards the susceptor 1 while the susceptor 1 is held in position. It should also be appreciated that in some embodiments, both the susceptor 1 and object 2 may be moved toward one another.

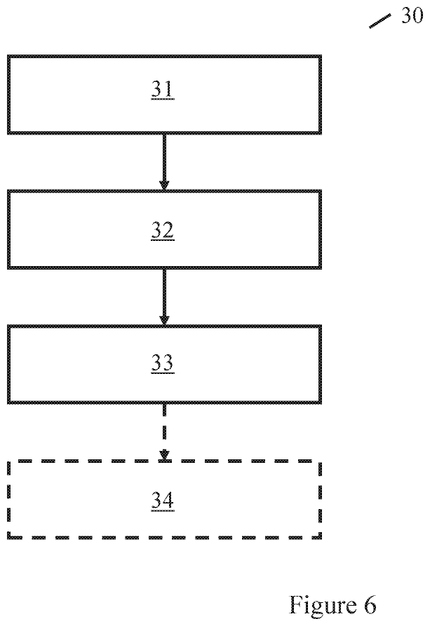

FIG. 6 shows a flow diagram of a method 30 of manufacturing a consumable for use with a non-combustible aerosol provision device, according to one embodiment. The method comprises providing 31 an object 2, the object 2 comprising aerosol-generating material 3, providing 32 a susceptor 1, and pulling 33 the susceptor 1 to at least partially embed the susceptor 1 in the object 2. The susceptor 1 may become fully embedded within the object 2.

In some embodiments, the pulling 33 comprises engaging a tool with the susceptor 1 and then using the tool to pull the susceptor 1 at least partially into the object 2. For example, the tool may engage with a leading end of the susceptor 1 such that the leading end is pulled by suitable actuation of the tool. Alternatively, the susceptor 1 may be pushed into the object 2. For example, the tool may engage with a trailing end of the susceptor 1 such that the trailing end of the susceptor 1 is pushed by suitable actuation of the tool. In either case, the direction of the applied force is such that the susceptor 1 is brought towards the object 2. In some embodiments, the engaging comprises gripping the susceptor 1 with the tool. In some embodiments, the pulling 33 comprises magnetically pulling the susceptor 1 at least partially into the object 2, with or without the source of the magnetic force engaging with the susceptor 1.

In some embodiments, the method 30 also comprises disengaging 34 the tool from the susceptor 1 when the susceptor 1 is at least partially embedded in the object 2.

The same tool may then be engaged with a subsequent susceptor 1 to be embedded in a different object 2 and the method may repeat.

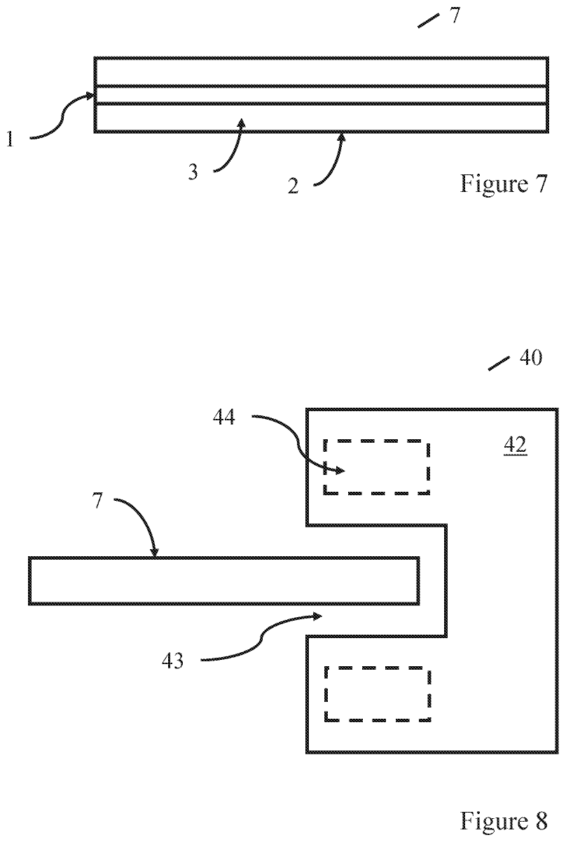

FIG. 7 shows a consumable 7 for use in a non-combustible aerosol provision device, according to one embodiment. The consumable 7 comprises an object 2 comprising aerosol-generating material 3, and a susceptor 1 at least partially embedded in the object 2. The susceptor 1 may be any susceptor 1 illustrated and discussed herein, or any variant thereof described herein, for example. For example, it may be a susceptor 1 made according to the method illustrated in FIG. 4.

The consumable 7 is, in this example, a cylindrical rod shape having a cylinder of aerosol-generating material 3 (e.g., tobacco or reconstituted tobacco), optionally including paper (or other suitable material) wrapped around the circumference of the cylinder of aerosol generating material. In some embodiments, the consumable 7 is manufactured according to any suitable method discussed herein. In particular, the consumable 7 may be manufactured according to the method discussed in relation to FIG. 5 or 6. The consumable 7 may be fully or partially formed once the susceptor 1 has been inserted into the object 2. That is, some additional manufacturing steps may be performed either before or after the susceptor 1 has been inserted into the object 2, e.g., a filter (such as a cellulose acetate plug) may be attached to an end of the object 2 (typically the end of the object 2 opposite to the end in which the susceptor 1 is inserted) before or after the susceptor 1 is inserted.

In some embodiments, the susceptor 1 is substantially coaxial with a central axis of the consumable 7, such as substantially coaxial with a central axis of the aerosol-generating material 3. Advantageously, this may lead to substantially uniform heating of the consumable 7, or aerosol-generating material 3, radially around the susceptor 1. Alternatively, the susceptor 1 may be at least partially embedded in any other suitable position in the consumable 7, such that heat generated by the susceptor 1 is transferred to the aerosol-generating material.

In some embodiments, the object may be the consumable. For example, while in some embodiments further manufacturing steps are made to the object to form the consumable (such as providing a filter), in other embodiments no further manufacturing steps are necessary to form the consumable from the object once the susceptor has been inserted.

FIG. 8 shows a schematic view of a non-combustible aerosol provision system 40 according to an embodiment of the invention. The non-combustible aerosol provision system 40 comprises the consumable 7 of FIG. 7; however, it should be appreciated that any suitable variant thereof described herein may alternatively be used.

The system also comprises a non-combustible aerosol provision device 42 for causing heating of the aerosol-generating material 3 of the consumable 7 to volatilise at least one component of the aerosol-generating material. The device 42 comprises a heating zone 43 for receiving the consumable 7 and a magnetic field generator 44 for generating a varying magnetic field for penetrating the susceptor 1 when the consumable 7 is in the heating zone 43, thereby causing heating of the aerosol-generating material 3.

In some embodiments, the device 42 is for causing heating of the aerosol-generating material 3 of the consumable 7 to volatilise at least one component of the aerosol-generating material 3 without burning the aerosol-generating material 3. In some embodiments, the device may be a tobacco heating device, also known as a tobacco heating product.

In some embodiments, the susceptor 1 is embedded in the object 2 after the object 2 has been cut to a desired length. As such, the susceptor 1 does not have to be cut on-line by the same cutting instrument that may cut a supply to length to form the object 2. Therefore, no or minimal modifications to cutting mechanisms of existing manufacturing systems are needed, and the likelihood of damaging such a cutting mechanism is significantly reduced or avoided as compared to cutting the object 2 to length from a supply after the susceptor 1 has been embedded.

In some embodiments, the susceptor 1 comprises one or more materials selected from the group consisting of: an electrically-conductive material, a magnetic material, and a magnetic electrically-conductive material. In some embodiments, the susceptor 1 comprises a metal or a metal alloy. In some embodiments, the susceptor 1 comprises one or more materials selected from the group consisting of: aluminium, gold, iron, nickel, cobalt, conductive carbon, graphite, steel, plain-carbon steel, mild steel, stainless steel, ferritic stainless steel, molybdenum, silicon carbide, cooper, and bronze.

In some embodiments, the aerosol-generating material is a non-liquid material. Alternatively or additionally, the aerosol-generating material comprises tobacco. In some embodiments, the aerosol-generating material comprises reconstituted aerosol-generating material, such as reconstituted tobacco.

The above embodiments are to be understood as illustrative examples of the invention. Further embodiments of the invention are envisaged. It is to be understood that any feature described in relation to any some embodiments may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A susceptor for at least partially embedding within an object during manufacture of a consumable for use with a non-combustible aerosol provision device, the object comprising aerosol-generating material,
wherein at least a portion of the susceptor has a non-linear cross-sectional shape perpendicular to a length of the susceptor.

2. The susceptor of claim 1, comprising a surface with at least one indentation therein, wherein the surface and the at least one indentation form the non-linear cross-sectional shape.

3. The susceptor of any one of claims 1 and 2, comprising at least one corrugation therein running parallel to the length of the susceptor, wherein the at least one corrugation forms the non-linear cross-sectional shape.

4. The susceptor of claim 3, wherein the non-linear cross-sectional shape is or comprises a crescent.

5. The susceptor of any one of claims 1 to 4, wherein at least one longitudinal end of the susceptor is tapered to aid insertion of the susceptor into the object.

6. A method of manufacturing a susceptor for at least partially embedding within an object during manufacture of a consumable for use in a non-combustible aerosol provision device, the object comprising aerosol-generating material, the method comprising:
providing at least a portion of a strip with a non-linear cross-sectional shape perpendicular to a length of the strip, the strip comprising susceptor material that is heatable by penetration with a varying magnetic field.

7. The method of claim 6, comprising dividing the strip from a supply.

8. The method of claim 7, wherein the dividing comprises using a cutter to cut the strip from the supply.

9. The method of claim 7 or claim 8, wherein the providing occurs after the dividing.

10. The method of claim 7 or claim 8, wherein the dividing occurs after the providing.

11. A consumable for use with a non-combustible aerosol provision device, the consumable comprising an object comprising aerosol-generating material and the susceptor of any one of claims 1 to 5 at least partially embedded in the object.

12. The consumable of claim 11, wherein the susceptor is substantially coaxial with a central axis of the consumable.

13. A method of manufacturing a consumable for use with a non-combustible aerosol provision device, the method comprising:
providing an object and the susceptor of any one of claims 1 to 5, wherein the object comprises aerosol-generating material; and
moving the susceptor and the object relative to each other so that the susceptor becomes at least partially embedded within the object.

14. A method of manufacturing a consumable for use with a non-combustible aerosol provision device, the method comprising:
providing an object, the object comprising aerosol-generating material;
providing a susceptor; and
pulling the susceptor to at least partially embed the susceptor in the object.

15. The method of claim 14, wherein the pulling comprises:
engaging a tool with the susceptor; and
then using the tool to pull the susceptor at least partially into the object.

16. The method of claim 15, wherein the engaging comprises gripping the susceptor with the tool.

17. The method of claim 15 or claim 16, comprising disengaging the tool from the susceptor when the susceptor is at least partially embedded in the object.

18. The susceptor of any one of claims 1 to 5, the method of any one of claims 6 to 10, the consumable of claim 11 or 12, or the method of any one of claims 13 to 17, wherein the susceptor comprises one or more materials selected from the group consisting of: aluminium, gold, iron, nickel, cobalt, conductive carbon, graphite, steel, plain-carbon steel, mild steel, stainless steel, ferritic stainless steel, molybdenum, silicon carbide, copper, and bronze.

19. The susceptor of any one of claim 1 to 5 or 18, the method of any one of claim 6 to 10 or 18, the consumable of claim 11, 12 or 18, or the method of any one of claims 13 to 18, wherein the susceptor comprises nickel.

20. The susceptor of any one of claim 1 to 5, 18 or 19, the method of any one of claim 6 to 10, 18 or 19, the consumable of claim 11, 12, 18 or 19, or the method of any one of claims 13 to 19, wherein the susceptor comprises steel with a nickel coating.

21. The susceptor of any one of claims 1 to 5 or 18 to 20, the method of any one of claims 6 to 10 or 18 to 20, the consumable of claims 11, 12 or 18 to 20, or the method of any one of claims 13 to 20, wherein the susceptor is hollow or perforated, or comprises indentations, a mesh or an expanded metal.

22. The susceptor of any one of claims 1 to 5 or 18 to 21, the method of any one of claims 6 to 10 or 18 to 21, the consumable of claims 11, 12 or 18 to 21, or the method of any one of claims 13 to 21, wherein the susceptor comprises a, pin, mesh or blade.

23. The susceptor, method or consumable of claim 22, wherein the susceptor comprises a plurality of pins, meshes or blades.

24. The susceptor of any one of claims 1 to 5 or 18 to 23, the method of any one of claims 6 to 10 or 18 to 23, the consumable of claims 11, 12 or 18 to 23, or the method of any one of claims 13 to 23, the susceptor comprising a plurality of apertures or recesses, wherein the apertures and/or recesses are filled with the aerosol-generating material when the susceptor is at least partially embedded in the object.

25. The susceptor of any one of claims 1 to 5 or 18 to 24, the method of any one of claims 6 to 10 or 18 to 24, the consumable of claims 11, 12 or 18 to 24, or the method of any one of claims 13 to 24, wherein at least part of the susceptor is annular.

26. The susceptor, method or consumable of claim 25, wherein the susceptor comprises a plurality of annular portions and, preferably, wherein the annular portions are arranged generally concentrically.

27. The susceptor of any one of claims 1 to 5 or 18 to 26, the method of any one of claims 6 to 10 or 18 to 26, the consumable of claims 11, 12 or 18 to 26, or the method of any one of claims 13 to 26, wherein the aerosol-generating material is non-liquid.

28. The susceptor of any one of claims 1 to 5 or 18 to 27, the method of any one of claims 6 to 10 or 18 to 27, the consumable of claims 11, 12 or 18 to 27, or the method of any one of claims 13 to 27, wherein the aerosol-generating material comprises tobacco.

29. The susceptor of any one of claims 1 to 5 or 18 to 28, the method of any one of claims 6 to 10 or 18 to 28, the consumable of claims 11, 12 or 18 to 28, or the method of any one of claims 13 to 28, wherein the susceptor extends the majority of the length of the object after the susceptor has been at least partially embedded in the object and, preferably, the susceptor extends substantially the entire length of the object after the susceptor has been at least partially embedded in the object.

30. The susceptor of any one of claims 1 to 5 or 18 to 29, the method of any one of claims 6 to 10 or 18 to 29, the consumable of claims 11, 12 or 18 to 29, or the method of any one of claims 13 to 29, wherein the susceptor comprises a first region of a first material and a second region of a second material, wherein the first and second materials are different.

31. The susceptor, method or consumable of claim 30, wherein the first and second materials have a different electrical conductivity and/or magnetic electrical conductivity.

32. The susceptor, method or consumable of claim 30 or claim 31, wherein one of the first material comprises a material that is heatable by penetration with a varying magnetic field and the second material comprises a material that is not, or substantially is not, heatable by penetration with a varying magnetic field.

33. The susceptor, method or consumable of any one of claims 30 to 32, wherein one of first and second materials is coated with the other one of the first and second materials.

34. The susceptor, method or consumable of claim 33, wherein the first material is coated with the second material.

35. The susceptor, method or consumable of any one of claims 30 to 34, wherein the first and second materials are configured such that, in use, when the first and second materials are penetrated by a varying magnetic field, the penetration of the first and second materials by the varying magnetic field causes a temperature difference between the first and second materials.

36. The susceptor, method or consumable of any one of claims 30 to 35, wherein the first and second materials have different thermal masses.

37. The susceptor of any one of claims 1 to 5 or 18 to 36, the method of any one of claims 6 to 10 or 18 to 36, the consumable of claims 11, 12 or 18 to 36, or the method of any one of claims 13 to 36, wherein the susceptor comprises a base portion and an embeddable portion, wherein the embeddable portion is configured to be at least partially embedded in the object.

38. The susceptor, method or consumable of claim 37, wherein the base portion is generally flat.

39. The susceptor, method or consumable of claim 37 or 38, wherein the base portion is generally circular.

40. The susceptor, method or consumable of any one of claims 37 to 39, wherein the base portion is comprises a material that is heatable by penetration with a varying magnetic field.

41. The susceptor, method or consumable of any one of claims 37 to 40, wherein the embeddable portion comprises a thermally conductive material.

42. The susceptor, method or consumable of any one of claims 37 to 41, wherein the embeddable portion comprises a material that is heatable by penetration with a varying magnetic field.

43. The susceptor, method or consumable of any one of claims 37 to 42, wherein the embeddable portion comprises a material that is not, or substantially is not, heatable by penetration with a varying magnetic field.

44. The susceptor, method or consumable of any one of claims 37 to 43, when dependent on any one of claims 30 to 36, wherein the embeddable portion comprises the first and second materials.

45. The susceptor, method or consumable of any one of claims 37 to 44, when dependent on any one of claims 30 to 36, wherein the embeddable portion comprises one of the first and second materials and the base portion comprises the other one of the first and second materials.

46. A consumable for use with a non-combustible aerosol provision device, the consumable being manufactured according to a method comprising the method of any one of claims 14 to 45.

47. The consumable of claim 46, wherein the susceptor is substantially coaxial with a central axis of the consumable.

48. A non-combustible aerosol provision system, comprising:
the consumable of any one of claims 11, 12, or 18 to 47; and
a non-combustible aerosol provision device for causing heating of the aerosol-generating material of the consumable to volatilise at least one component of the aerosol-generating material;
wherein the device comprises a heating zone for receiving the consumable, and a magnetic field generator for generating a varying magnetic field for penetrating the susceptor when the consumable is at least partially in the heating zone, thereby to cause heating of the aerosol-generating material.

49. The system of claim 48, wherein the device is for causing heating of the aerosol-generating material of the consumable to volatilise at least one component of the aerosol-generating material without burning the aerosol-generating material.

50. The system of claim 48 or 49, wherein the magnetic field generator comprises at least one coil.

51. The system of claim 50, wherein the coil is helical.

52. The system of claim 50, wherein the coil is a flat coil and, preferably, is a two-dimensional spiral.

53. The system of claim 52, comprises a second coil and, preferably, the second coil is helical.

54. The system of any one of claims 48 to 53, when dependent on any one of claims 37 to 45, wherein the magnetic field generator is configured to generate a varying magnetic field for penetrating the base portion of the susceptor when the consumable is at least partially in the heating zone.

55. The system of claim 54, when dependent on claim 53, wherein the coil is configured to generate a varying magnetic field for penetrating the base portion of the susceptor when the consumable is at least partially in the heating zone and wherein the second coil is configured to generate a varying magnetic field for penetrating the embeddable portion of the susceptor when the consumable is at least partially in the heating zone.

56. The system of claim 55, wherein the second coil extends about the circumference of at least a portion of the embeddable portion of the susceptor.
